(19) United States
(12) Patent Application Publication
(10) Pub. No.: US 2013/0063449 A1
(43) Pub. Date: Mar. 14, 2013

(54) METHOD AND SYSTEM FOR PREPROCESSING AND PROVIDING INFORMATION FOR OPERATING A TECHNICAL INSTALLATION

(71) Applicants: Stefan H. LEITNER, Heidelberg (DE); Jens Doppelhamer, Ladenburg (DE); Wolfgang Mahnke, Hettenleidelheim (DE)

(72) Inventors: Stefan H. LEITNER, Heidelberg (DE); Jens Doppelhamer, Ladenburg (DE); Wolfgang Mahnke, Hettenleidelheim (DE)

(73) Assignee: ABB AG, Mannheim (DE)

(21) Appl. No.: 13/610,174

(22) Filed: Sep. 11, 2012

Related U.S. Application Data
(63) Continuation of application No. PCT/EP2011/001153, filed on Mar. 9, 2011.

(30) Foreign Application Priority Data
Mar. 11, 2010 (DE) 10 2010 011 190.2

(51) Int. Cl. G06T 1/00

(52) U.S. Cl. 345/501

(57) ABSTRACT

A method is disclosed for preprocessing and providing data and information of an automation system, wherein temporally variable first data or information and temporally invariable second data or information are acquired by using at least one standardized interface. The acquired first data and the acquired second data are read in, processed, via at least one standardized interface, and reproduced for display as a whole, and/or provided for further utilization and for operating a technical installation.

### RELATED APPLICATION(S)

This application claims priority as a continuation application under 35 U.S.C. §120 to PCT/EP2011/001153, which was filed as an International Application on Mar. 9, 2011, designating the U.S., and which claims priority to German Application No. 10 2010 011 190.2 filed on Mar. 11, 2010. The entire contents of these applications are hereby incorporated by reference in their entireties.

### FIELD

The disclosure relates to a method for pre-processing and providing data and information for operating a technical installation, for example, an automation system. According to an exemplary method, temporally variable first data, such as, time series information or data, and temporally invariable second data are acquired using at least one standardized interface, and are processed. The disclosure also relates to a device for preprocessing and providing data and information for operating a technical installation, for example, an automation system, and for executing the aforementioned method.

### BACKGROUND INFORMATION

In information technology, the term information model is understood to be an abstract formal representation of elements, their characteristics and relations and the operations which can be carried out with them or by them.

An information model can be defined in such a manner that it does not use any particular implementation. Standardized information models and associated interfaces therefore allow implementation-independent and manufacturer-independent access to different data and thus also a relatively easier or simplified exchange of data and information between different technical installations and/or installation components.

An established standard for accessing data, for example in the technical field of automation, namely the OPC DA, is known.

However, this standard has offered, for example, restricted possibilities for information modeling and processing. For example, elements could only be represented and provided arranged statically and hierarchically in which only some characteristics of the elements which are simple to represent could be represented which leads to unsatisfactory results in operation and handling, for example, in the case of operation of more complex technical installations and, as a consequence, uses an increased processing effort, for example with respect to resources and processing time needed.

For the efficient and safeguarded operation of a technical installation and of relevant installation components, a specification for a more efficient and more extensive possibility of reproducing and linking complex information and for example, for reproducing as a whole and/or displaying complex characteristics of the elements, of relations of the elements with respect to one another or of possible operations which can be carried out by means of the elements or are carried out by these.

The disclosure provides a method and a device by which an automation system can be operated, monitored and handled, reliably and efficiently in spite of complex structure and a multiplicity of information, data and quantities to be acquired and to be taken into consideration.

### SUMMARY

A method for preprocessing and providing data and information of an automation system is disclosed, comprising: acquiring temporally variable first data or information and temporally invariable second data or information using at least one standardized interface; processing the first data and the second data or information via the at least one standardized interface; and displaying the processed first data and the second data or information as a whole.

A system for preprocessing and providing data and information of an automation system is disclosed, comprising: at least one data processing device, configured for interaction with at least one standardized interface, for acquiring temporally variable first data and temporally invariable second data for reading in, and for processing first data and the second data via the at least one standardized interface; and at least one output device for displaying processed first data and the second data or information as a whole for retrieval and/or for further utilization and for operating a technical installation.

A computer program product comprising a non-transitory computer readable medium having a computer readable code embodied therein for preprocessing and providing data and information of an automation system is disclosed, the computer readable program code configured to execute a process, which includes: acquiring temporally variable first data or information and temporally invariable second data or information using at least one standardized interface; processing the first data and the second data or information via the at least one standardized interface; displaying the processed first data and the second data or information as a whole; and providing the processed first data and the second data or information for further utilization and/or for operating a technical installation.

### BRIEF DESCRIPTION OF THE DRAWINGS

The disclosure is explained below with reference to the exemplary embodiments shown in the drawings. In the drawings:

FIG. 1 shows a combined use of graphs and line charts;

FIG. 2 shows a combined use of graphs, text fields and bar charts; and

FIG. 3 shows a combined use of graphs, pictograms and event lists.

### DETAILED DESCRIPTION

According to the disclosure, temporally variable first data and information and temporally invariable second data and information are acquired for preprocessing and providing information for operating a technical installation, for example, in interaction with sensors and/or a higher-level management or control system, and read in, processed (for example, preprocessed via at least one standardized interface), and reproduced or displayed as a whole and/or provided for further utilization, and for operating a technical installation.

Accordingly, the disclosure provides that dynamic data and information (first data), for example, real-time data such as, for example, measurement values, events and time series, which are updated continuously or at least cyclically such as in interaction with sensors and/or measurement value sensors and/or signal generators and/or key switches, and are temporally variable, are processed combined with data and information (second data) of elements, their relations and/or dependences and characteristics or peculiarities which are not updated, namely so-called static data and information, and are reproduced and/or provided in preprocessed form displayed as a whole.

For example, continuous updating can comprise a cyclic updating of data and information in freely selectable or predeterminable time intervals and/or an event-dependent and/or inquiry-dependent updating or an event-dependent and/or inquiry-dependent reading-in of data or information, for example by activating a pushbutton or function area provided for this purpose.

For example, the combination of data and information allows a number of data types to be displayed jointly and represented and/or reproduced in an updateable or updated view structured, and which creates the possibility of reliably monitoring and checking and/or handling or operating a technical installation and especially an automation system and/or power station and/or supply or distribution network in spite of its complex structure and a multiplicity of data, inputs and quantities to be acquired and/or to be taken into consideration.

In an exemplary embodiment, a standardized information model is generated and/or used, which processes first dynamic and second static data and places them in relation to one another by means which implement predeterminable rules and/or relations and linkages, and which provides and/or represents them structured jointly in a view.

In information technology, the term information model is understood to be an abstract formal representation of elements, their characteristics and relations and the operations which can be carried out with them or by them. An information model can be defined in such a manner that it does not require any particular implementation. Standardized information models and associated interfaces therefore allow implementation-independent and manufacture-independent access to different data and information of the most varied technical installations, systems and components and thus also enable different components and means to be linked and to interact and cooperate. A display of data of, for example, automation systems can be facilitated by standardized information models. Different types of representation or reproduction and/or provision of data and information, for example, data and information of a technical type, can be combined without problems by using a standardized information model. With the aid of a standardized information model, automation systems can also be monitored, configured and controlled by system management from a distance.

In another embodiment, an information model standardized in accordance with the “ABB Aspect Object Model” is used. For example, the information model can be combined with other ABB modules. The aforementioned aspect object model comprises aspect objects, aspects and properties or capabilities and/or characteristics and/or peculiarities. For example, aspect objects represent objects of the real world, for example, an engine or a temperature sensor and artificial units, for example, an area in the factory. Aspects represent different aspects of an aspect object, for example, the user's manual in the case of an engine, an icon (small image) or place marker for the engine, or also the current values of the engine, for example, the engine is on/off, current speed and the like. Each aspect object can have a number, especially many, and also very different aspects. Aspects offer so-called “properties” which provide information of the aspect in a simple-to-read and simple-to-write manner, for example the engine status or the speed.

Aspect objects are organized in various structures, and form in each case a type of tree arrangement and/or hierarchical structure in that one aspect object lies underneath the other one. There are various structures and/or arrangements, for example in order to offer the functional view or the control view of a system.

Aspect object types (AOTs) represent the respective “types” of aspect objects. Each aspect object can be allocated to such a type. For example, an AOT can define a type of engine and each aspect object which represents such an engine is of this type. The aspect objects then take over the characteristics of the AOT such as for example the icon. However, this can be exchanged by a special icon on an aspect object. However, the AOT can specify that an icon or place manner has to exist.

AOTs support heredity, for example, an AOT can inherit from another, general type and take over and refine its characteristics. For example there can be a general engine type from which actual engine models inherit. Similar to the aspect objects, aspects are also typed and have an aspect type which defines the precise characteristics of the respective aspect.

The information about both aspect and aspect object types can be read out of a corresponding system, for example, an 800xA system by the company ABB, and/or utilized via interfaces.

In a further embodiment according to the method, an information model standardized in accordance with the OPC UA standard can be used. The information model can be standardized to be manufacturer-neutral. In automation technology and/or the power supply field, standardized and comprehensive information models and associated interfaces are being developed for manufacturer-independent, platform-independent and programming language-independent access to stocks of data of automation systems and/or power supply systems. One such standard is, for example, OPC UA. In these information models, alarms, events, time series, measurement values, objects and object types and different types of relations can advantageously be represented. The comprehensiveness of these information models enables among other things, manufacturer-independent and platform-independent applications for displaying and/or further processing or utilization of the data of automation and/or power supply or distribution systems, respectively, to be generated for a variety of task areas.

For example, the address space model of OPC UA comprises nodes which, for example, are used as exchange elements or connection elements for data and/or information exchange which are connected by references. The basic types of node are objects, variables, methods, data type and view. Objects represent objects of the real world or artificial units. Objects can be complex and built up of other objects, variables and methods. A variable offers the possibility of reading or writing information of the objects in a simple manner. The data types used for this purpose are extendable and thus also a component of the address space. Methods offer the possibility of calling up certain functionalities of an object selectively such as, for example, the calibration of a measuring instrument or measuring sensor.

“Views” restrict the references and thus the number of visible nodes and thus make it possible to reach the respective information which is used for a particular task in a comparatively simple manner in complex address spaces.

Objects and variables are typed and there are accordingly object types and types of variables as further types of nodes. Each object is allocated to an object type, each variable is allocated to a type of variable. The types can define a complex structure having sub-nodes which are also present in the entities of the type. In this example, the type information is present in the address space of OPC UA and can be accessed using the same mechanisms as the entity information.

To express various types of relations between the nodes, the references are typed in OPC UA. Accordingly there are reference types as further type of node. Reference types are extendable, for example, a server can use its own reference types. The information about this exists in the address space.

In OPC UA, an information model designates a model based on the address space model. Certain types and entities and their semantics are specified. In order to achieve a uniform representation of information in OPC UA, it is possible to standardize such an information model. This has become known, for example, in a standardized information model for analysis devices.

In a further embodiment of the disclosure, the first data and/or the second data are represented in graphs. Graphs are suitable for representing relations between elements, for example, between two, three and more elements.

The first data and/or the second data are represented in diagrams. Diagrams are formed as line or bar charts. This enables the user to rapidly acquire trend changes in the data. Line or bar charts are suitable for representing time series and/or dynamic data and information. However, the predictive displaying of future developments or trends with regard to acquired measurement quantities and thus with regard to an installation behaviour to be expected or an installation state is also possible in a comparatively simple manner.

In a further exemplary embodiment, the first data and/or the second data are acquired in text fields. Measured values can be specified by means of text fields. It is possible to specify values of up to any number of decimal places.

Also, the first data and/or the second data can be represented or specified in pictograms. A pictogram can be represented as a variable symbol, for example, one that lights up and/or changes geometrically and/or moves. For example, incandescent bulbs, flashes, exclamation marks or oil cans can be used as symbols. For example, the respective symbol can also be linked to a pushbutton or designed as a pushbutton.

In a further embodiment, the first data and/or the second data are represented in event lists. Event lists reliably indicate events in an automation system. The user can acquire and immediately recognize events in chronological order.

The first data and/or the second data can be represented also in configurable views in a further variant of the embodiment. By means of this specific embodiment, the data and information can be configured and specified user-specifically.

According to an exemplary method, an automatic generation means can generate displays of object entities using standardized object types in a further embodiment, wherein, for example, a specific representation is parameterized for a respective type of resource, for example, type of pump, and/or is used and/or can be used for the respective technical resources, for example, pumps, of the type.

It can also be provided for example that a display or specification of a respective reactor type which references other types such as, for example, boilers, valves, pumps and the like, can be generated from displays of the types referenced, and/or an automatic arrangement and/or sequencing or grouping of the respective objects can be effected. This can be effected, for example, by means (e.g., a processor) for processing of spatial relations or linkages, wherein, for example, the relation “spatially contained in” “boiler17,” “boiler house1” could be displayed by the symbols for boiler and boiler house being contained or integrated, and/or effected by method-related relations or linkages, wherein, for example, the relation “connected to,” “tank1,” “pipeline3” could be indicated connected to one another by symbols for tank and pipeline.

As further development, views which selectively display the object and its immediate environment—“connected to”—can be generated for an object.

In an exemplary embodiment, an automatic generation of navigation elements between displays and/or place markers of objects can also be effected, wherein, for example, a tank displayed or another technical resource points on one of its sides, for example, on its left-hand side, to object types with which it has, for example, a method-related relation, and/or points to these and/or indicates these.

Furthermore, it can be provided according to an exemplary method that preprocessing, for example, filtering, of the respective data or information, is carried out or effected for generating task-specific or demand-dependent views, for example with regard to maintenance, operation or piping, this only comprising, for example, objects of the pipeline type and their characteristics, electricity and/or instrumentation.

In a further embodiment, references between data sources, for example, relations between objects, can be generated and/or utilized on different servers.

All examples can be used and/or applied for metadata standardized openly or in a manufacturer-specific manner.

In accordance with another exemplary embodiment, a system for preprocessing and providing information for operating a technical installation is disclosed. The system can have at least one processing device, for example, a process unit, and at least one standardized interface which reads in, processes, (for example, preprocesses) first data and information which is temporally variable and second data and information which is temporally invariable and via the at least one standardized interface reproduces them, displayed as a whole in a view on or via at least one output device and/or provides them for retrieval and for further utilization and for operating a technical installation.

According to an exemplary system, dynamic data and information (first data), for example, also real-time data (such as, measurement values, events and time series which, for example, in interaction with sensors and/or measurement value sensors and/or signal generators and/or key switches and/or the relevant views are continuously updated and are temporally variable), are processed, combined with data and information (second data) of elements, their relations and/or dependencies and characteristics or peculiarities, which are not continuously updated (e.g., so-called static data and information) and are specified or reproduced and/or provided in preprocessed form, displayed as a whole via at least one output device.

It can also be provided that the continuous updating comprises a cyclic updating of data and information in freely selectable or predeterminable time intervals and/or an event-dependent and/or inquiry-dependent updating or an event-dependent and/or inquiry-dependent reading-in of data or information, for example, by activating a pushbutton provided for this purpose.

In a further embodiment, the at least one output device can comprise a display device such as, for example, a monitor or a touch screen, a printer or plotter and/or an interface for conveying information and data to, a for example, higher-level management system.

The interface can be a wire-connected interface, for example, a LAN, WAN, Ethernet, PROFIBUS and/or USB interface or a wireless interface, for example, a Bluetooth, WLAN, radio or IR interface.

In a further embodiment of the disclosure, the first data and/or the second data are represented in or, respectively, as graphs in the interaction of processing device and output device, for example, a display device. Graphs are suitable for representing relations between elements, for example, between two, three and more elements.

The first data and/or the second data can be represented in diagrams in the interaction of processing device and output device. Diagrams can be advantageously formed as line or bar charts. This enables the user to rapidly acquire trend changes in the data. Line or bar charts are especially suitable for representing time series and/or dynamic data and information. However, the predictive displaying of future developments or trends with regard to acquired measurement quantities and thus with regard to an installation behaviour to be expected or an installation state is also advantageously possible in a comparatively simple manner.

In a further exemplary embodiment, masks comprising at least one text field are provided in the interaction of processing device and output or display device, in which text fields the first data and/or the second data can be acquired. Measured values can be specified very precisely by means of text fields. It is possible to specify values of up to any number of decimal places.

Also, the first data and/or the second data can be represented or specified in pictograms in the interaction of processing device and output or display device. A pictogram can be represented as a variable symbol, for example, one that lights up and/or changes geometrically and/or moves. For example, incandescent bulbs, flashes, exclamation marks or oil cans can be used as symbols. For example, the respective symbol can also be linked to a pushbutton or constructed as a pushbutton.

In a further embodiment, the first data and/or the second data are provided and/or represented in event lists. Event lists reliably indicate events in an automation system. The user can acquire and immediately recognize events in chronological order.

The first data and/or the second data can be represented also in configurable views in the interaction of processing device and display device in a further variant of the embodiment. By means of this specific embodiment, the data and information can be configured and specified user-specifically.

According to the system, generation of a view for the automatic generation of displays of object entities using standardized object types is provided in a further embodiment, wherein, for example, a specific representation is parameterized for a respective type of resource, for example, type of pump, and/or is used and/or can be used for the respective technical resource, for example, pumps, of the type.

It can also be provided, for example, that a display or specification of a respective reactor type which references other types such as, for example, boilers, valves, pumps and the like, can be generated from displays of the referenced types, and/or an automatic arrangement and/or sequencing or grouping of the respective objects can be effected. This can be effected, for example, by means (e.g., processor) for processing spatial relations or linkages wherein, for example, the relation “spatially contained in,” “boiler17,” “boiler house1” could be displayed by the symbols for boiler and boiler house being contained or integrated, and/or effected by method-related relations or linkages, wherein, for example, the relation “connected to,” “tank1,” “pipeline3” could be indicated connected to one another by symbols for tank and pipeline.

As further development, views which selectively display the object and its immediate environment—“connected to”—can be generated for an object.

In an exemplary embodiment, an automatic generation of navigation elements between displays and/or place markers of objects can also be effected by means for generation of views, wherein, for example, a tank displayed or another technical resource points on one of its sides, for example, on its left-hand side, to object types with which it has, for example, a method-related relation and/or points to these and/or indicates these.

Furthermore, it can be provided according to the system that preprocessing, for example filtering, of the respective data or information is carried out or effected for generating task-specific or demand-dependent views, for example with regard to maintenance, operation or piping, this only comprising, for example, objects of the pipeline type and their characteristics, electricity and/or instrumentation.

In a further embodiment, references between data sources, for example relations between objects, can be generated and/or utilized on different servers.

All examples can be used and/or applied for metadata standardized openly or in a manufacturer-specific manner.

To avoid further repetitions with respect to the disclosed activity, reference with respect to the system is made to the embodiments and to the method as such.

The aforementioned device can carry out individually or in combination all steps which are described and/or claimed by the method.

In conjunction with the explanation of exemplary embodiments of the disclosure by the drawings, generally exemplary embodiments and developments of the teaching will also be explained.

Within the embodiments of the present disclosure, the term information model is understood to be an abstract, formal representation of elements, their characteristics and relations and the operations which can be carried out with them or by them.

An information model can be defined in such a manner that it does not require any particular implementation. For this reason, standardized information models and associated interfaces allow implementation-independent and manufacturer-independent access to different data.

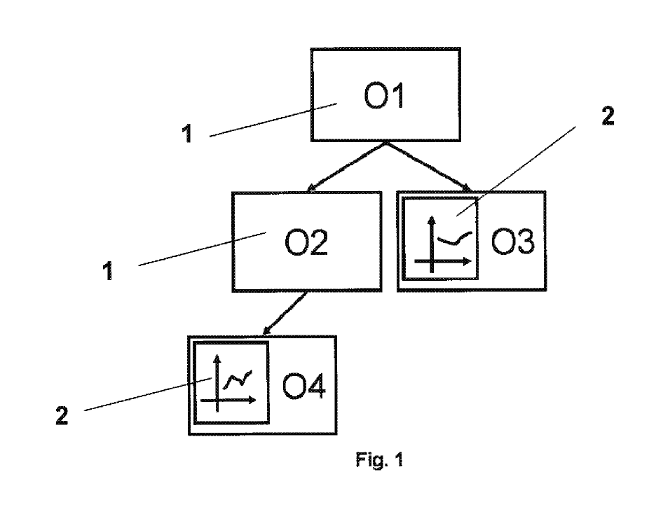

FIG. 1 shows a combined use of graphs 1 and line charts 2 for representing elements, relations between elements and time series. In this example, the time series are continuously updated in order to indicate the variation with time of a variable quantity in the automation system within a particular period up to the present.

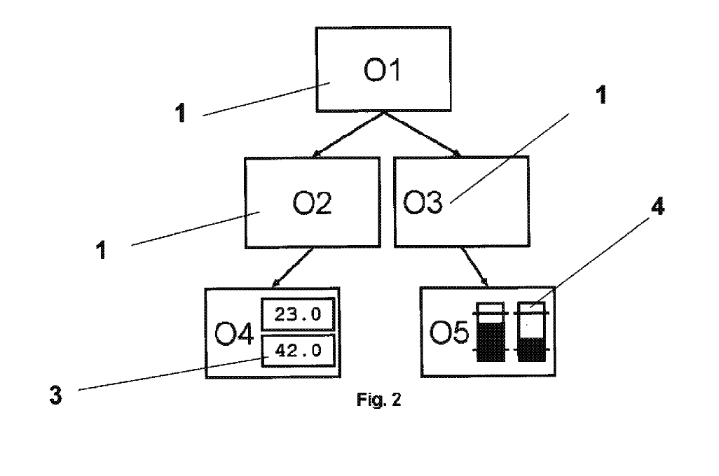

FIG. 2 shows a combined use of graphs 1, text fields 3 and bar charts 4 for representing elements, relations between the elements and numeric measurement values. In this example, the representations of the measurement values are continuously updated in order to indicate in each case the current value of a variable quantity in the automation system.

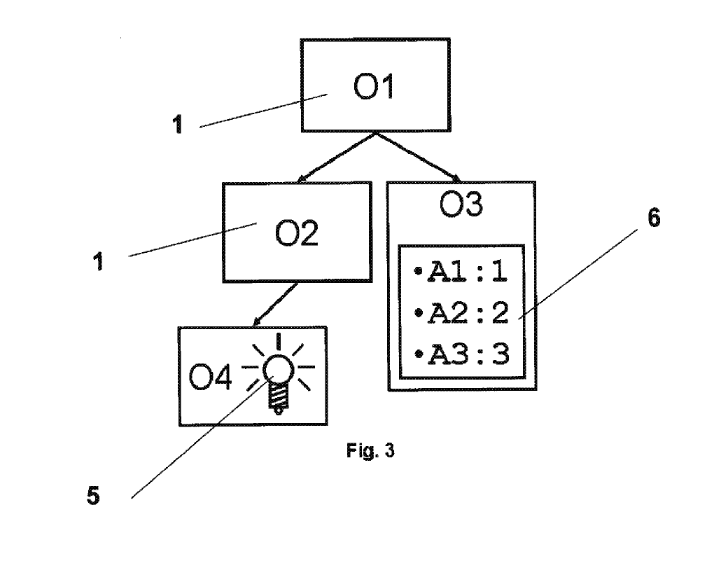

FIG. 3 shows a combined use of graphs 1, pictograms 5 and event lists 6 for representing elements, relations between the elements and events. In this example, the representations of the events are continuously updated as pictograms 5 or event lists 6 in order to indicate events in the automation system.

All the representations of FIGS. 1 to 3 have in common that the selection of elements, relations and characteristics to be represented is configurable for each representation. The arrangement of the elements in a view or a diagram can be generated automatically or also configured. The selection of the elements to be represented updated and the type of representation can be configured or made automatically by means (e.g., a processor) which produce the comprehensive information model.

In accordance with an embodiment, transformations of model and standardized meta-model can be carried out or effected in display description data, wherein, for example, an automatic generation of displays of object entities can be effected by using a processor and standardized object types, such as, for example, a specific representation of a respective pump type is parameterized and/or used and/or employed for the respective pumps of the type and/or a display of a respective reactor type which references other types such as, for example, boilers, valves, pumps and the like can be generated from displays of the referenced types.

In a further embodiment, an automatic or automated arrangement and/or sequencing or grouping of the respective objects can be effected in accordance with the system and the method, such as by means (e.g., a processor) for processing spatial relations or linkages, wherein, for example, the relation “spatially contained in,” “boiler17,” “boiler house1” can be displayed by the symbols for boiler and boiler house being contained or integrated, and/or by method-related relations or linkages. In this manner, for example, the relation “connected to,” “tank1,” “pipeline3” could indicate connected to one by symbols for tank and pipeline, wherein views which selectively display the object and its immediate environment—“connected to”—are generated for an object.

In accordance with an embodiment, an automatic generation of navigation elements is effected or can be effected between displays of objects, wherein, for example, a tank displayed or another technical resource points on one of its sides, for example, on its left-hand side, for example, object types with which it has, for example, a method-related relation and/or points to these and/or indicates these and/or filtering of the data or information can be carried out for generating task-specific or demand-dependent views, for example, with regard to maintenance, operation or view to piping wherein in this case, for example, only the objects of the pipeline type and their characteristics can be comprised, electricity and/or instrumentation, and/or references between data sources, for example, relations between objects can be generated and/or utilized on different servers.

All examples can be used and/or applied for metadata standardized openly or in a manufacturer-specific manner.

With regard to other exemplary embodiments and developments of the teaching according to the disclosure, reference is made, on the one hand to the general description herein, and, on the other hand, to the patent claims.

A computer program product for execution on a correspondingly arranged non-transitory data processing device which can implement features of the method according to the disclosure leads to an exemplary embodiment of the system according to the disclosure. A computer program product, for example, a computer program stored on a non-transitory data medium, which has the features of the method according to the disclosure, is therefore included expressly in the content of disclosure of the present application.

The present disclosure also comprises any combinations of exemplary embodiments and of individual design features or developments, unless they are mutually exclusive.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Graph
2 Line chart
3 Text field
4 Bar chart
5 Pictogram
6 Event list

What is claimed is:

1. A method for preprocessing and providing data and information of an automation system, comprising:
acquiring temporally variable first data or information and temporally invariable second data or information using at least one standardized interface;
processing the first data and the second data or information via the at least one standardized interface; and
displaying the processed first data and the second data or information as a whole.

2. The method of claim 1, comprising:
providing the processed first and the second data or information for further utilization and/or for operating a technical installation.

3. The method of claim 1, comprising:
generating or using a standardized information model which places the first data and the second data in relation to one another and represents them combined relation-dependently in a view.

4. The method of claim 3, wherein the standardized information models is generated in accordance with an “ABBs Aspect Object Model” standard.

5. The method of claim 3, wherein the standardized information model is generated in accordance with the OPC UA standard.

6. The method of claim 1, wherein the first data and/or the second data are provided and/or represented in graphs, diagrams, text fields, pictograms and/or event lists.

7. The method of claim 1, wherein the first data and/or the second data are represented in event lists.

8. The method of claim 1, comprising:
displaying the first data and/or the second data and/or the information in a visual form on a wireless or wire-connected interface, a printer or plotter, a monitor or a touch screen.

9. A system for preprocessing and providing data and information of an automation system, comprising:
at least one data processing device, configured for interaction with at least one standardized interface, for acquiring temporally variable first data and temporally invariable second data for reading in, and for processing first data and the second data via the at least one standardized interface; and
at least one output device for displaying processed first data and the second data or information as a whole for retrieval and/or for further utilization and for operating a technical installation.

10. The system of claim 9, wherein the output device is a wireless or wire-connected interface, a printer or plotter.

11. The system of claim 9, wherein the output device is a monitor or a touch screen.

12. The system of claim 9, wherein the processing device is configured for generating or receiving a standardized information model which places the first data and the second data in relation to one another and represents them combined relation-dependently in a view.

13. The system of claim 12, wherein the standardized information model is generated in accordance with the “ABBs Aspect Object Model” standard.

14. The system of claim 12, wherein the standardized information model is generated in accordance with the OPC UA standard.

15. The system of claim 9, wherein the first data and/or the second data are provided and/or represented in graphs, diagrams, text fields, pictograms and/or event lists.

16. The system of claim 9, wherein the first data and/or the second data are represented in event lists.

17. The system of claim 9, wherein
the temporally variable first data is measurement values, events and time series, which are updated continuously or at least cyclically; and
the temporally invariable second data is static data and information which is not updated.

18. The system of claim 17, wherein the temporally variable first data and temporally invariable second data relate to sensors, measurement value sensors, signal generators and/or key switches.

19. A computer program product comprising a non-transitory computer readable medium having a computer readable code embodied therein for preprocessing and providing data and information of an automation system, the computer readable program code configured to execute a process, which includes:
acquiring temporally variable first data or information and temporally invariable second data or information using at least one standardized interface;
processing the first data and the second data or information via the at least one standardized interface;
displaying the processed first data and the second data or information as a whole; and
providing the processed first data and the second data or information for further utilization and/or for operating a technical installation.

20. The computer program product of claim 19, wherein the process comprises:
generating or receiving a standardized information model which places the first data and the second data in relation to one another and represents them combined relation-dependently in a view.
